(19) United States
(12) Patent Application Publication
(10) Pub. No.: US 2008/0089760 A1
(43) Pub. Date: Apr. 17, 2008

(54) Fastener device for plasterboard

(76) Inventor: Chun I. Yao, Taichung (TW)

Correspondence Address: CHARLES E. BAXLEY, ESQ., 90 JOHN STREET, THIRD FLOOR, NEW YORK, NY, 10038, US

(21) Appl. No.: 11/582,004

(22) Filed: Oct. 17, 2006

(51) Int. Cl. F16B 15/00

(52) U.S. Cl. 411/477

(57) ABSTRACT

A fastener device includes a fastener member having a planar element and having a tip for engaging into a plasterboard, and an anchoring device having one or more teeth formed on the planar element for engaging with the plasterboard and for preventing the fastener member from being disengaged from the plasterboard. A cutting member is disposed between the planar element and the tip for facilitating an engagement of the fastener member into the plasterboard. The planar element may include one or more reinforcing ribs for reinforcing the fastener member, and an enlarged head for limiting an engagement of the fastener member into the plasterboard.

### BACKGROUND OF THE INVENTION

1. Field of the Invention

The present invention relates to a fastener device, and more particularly to a fastener device for attaching or securing plasterboards together or for attaching or securing plasterboards to the other supporting objects or walls and for preventing the fastener device from being disengaged from the plasterboards and/or the supporting objects or walls.

2. Description of the Prior Art

Typical plasterboards have been developed and provided for building construction purposes, and the plasterboards are required to be secured together or required to be secured to the other supporting objects or walls with various kinds of fastener devices or fastener strips or the like.

For example, U.S. Pat. No. 3,167,778 to Decot et al. discloses one of the typical fastener packages comprising an elongated holding strop for holding or supporting a number of fasteners or nails.

When the plasterboards are fastened or secured together or secured to the other supporting objects or walls with such kinds of fasteners or nails, the fasteners or nails may have a good chance to be disengaged from the plasterboards and/or the supporting objects or walls, and the plasterboards may have a good chance to be broken by the fasteners or nails.

U.S. Pat. No. 5,758,768 to Habermehl et al. discloses another typical supporting deflective screwstrip comprising a number of screws or threaded fasteners supported on a plastic holding strip. Similarly, when the plasterboards are fastened or secured together or secured to the other supporting objects or walls with such kinds of threaded fasteners, the plasterboards may have a good chance to be broken by the threaded fasteners.

The present invention has arisen to mitigate and/or obviate the afore-described disadvantages of the conventional fastener devices for plasterboards.

### SUMMARY OF THE INVENTION

The primary objective of the present invention is to provide a fastener device for attaching or securing plasterboards together or for attaching or securing plasterboards to the other supporting objects or walls and for preventing the fastener device from being disengaged from the plasterboards and/or the supporting objects or walls and for preventing the plasterboards from being broken by the fastener device.

In accordance with one aspect of the invention, there is provided a fastener device comprising a fastener member including a planar element having a tip extended from a lower portion thereof for engaging into a plasterboard, and including an anchoring device provided thereon for engaging with the plasterboard and for preventing the fastener member from being disengaged from the plasterboard.

The planar element of the fastener member includes a cutting member provided between the planar element and the tip for facilitating an engagement of the fastener member into the plasterboard.

The cutting member includes at least one cutting edge provided therein for facilitating the engagement of the fastener member into the plasterboard. The cutting member includes a wider upper portion adjacent the fastener member and includes a narrower lower portion adjacent the tip for being formed as a wedge-shape.

The anchoring device includes at least one tooth extended from the planar element. The tooth is preferably a ratchet tooth for solidly engaging with the plasterboard and for preventing the fastener member from being disengaged from the plasterboard.

The planar element of the fastener member includes at least one first reinforcing rib extended therefrom for reinforcing the fastener member. The first reinforcing rib is extended from one side of the planar element of the fastener member. The planar element of the fastener member may further include at least one second reinforcing rib extended therefrom for further reinforcing the fastener member. The second reinforcing rib is extended from another side of the planar element of the fastener member opposite to the first reinforcing rib.

The planar element of the fastener member includes an enlarged head provided on an upper portion of the fastener member for engaging with the plasterboard and for limiting an engagement of the fastener member into the plasterboard. The enlarged head is preferably perpendicular to the planar element of the fastener member. The enlarged head of the planar element of the fastener member includes a curved recess formed in an upper portion thereof.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a fastener device in accordance with the present invention;

FIG. 2 is a perspective view illustrating one of the fastener members of the fastener device;

FIG. 3 is a front plan schematic view of the fastener member of the fastener device;

FIG. 4 is a side plan schematic view of the fastener member of the fastener device;

FIG. 5 is a top plan schematic view of the fastener member of the fastener device;

FIG. 6 is a bottom plan schematic view of the fastener member of the fastener device;

FIG. 7 is a perspective view illustrating the other arrangement of the fastener device; and

FIG. 8 is a front plan schematic view of the fastener member of the fastener device as shown in FIG. 7.

### DETAILED DESCRIPTION OF THE PREFERRED EMBODIMENT

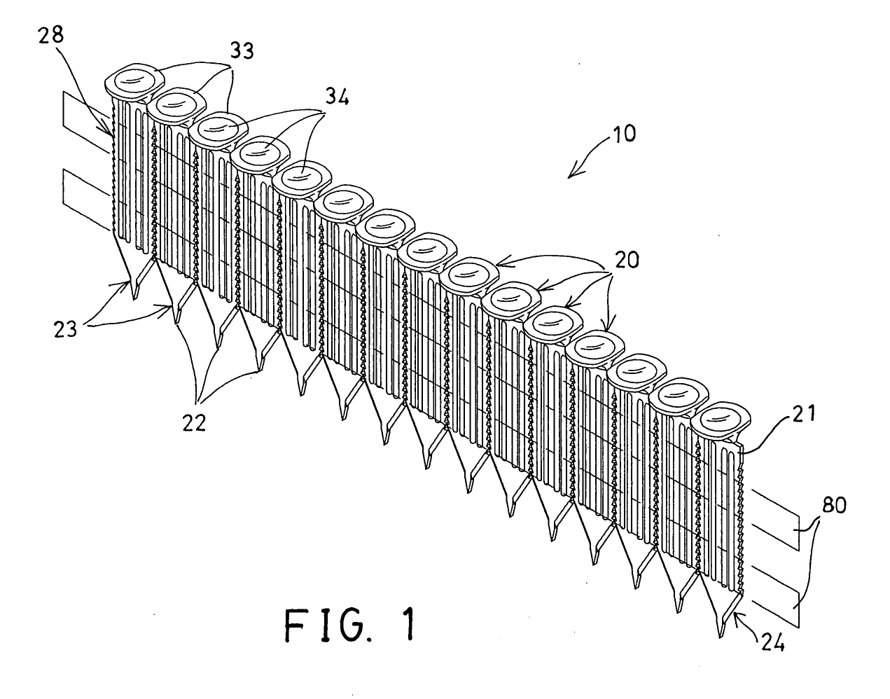

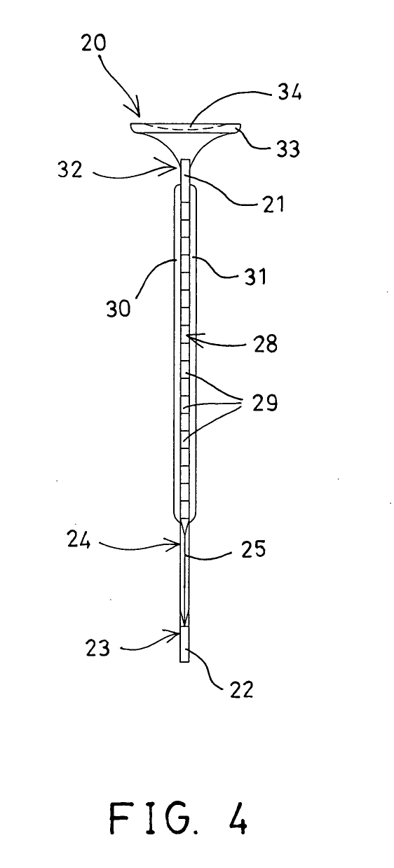

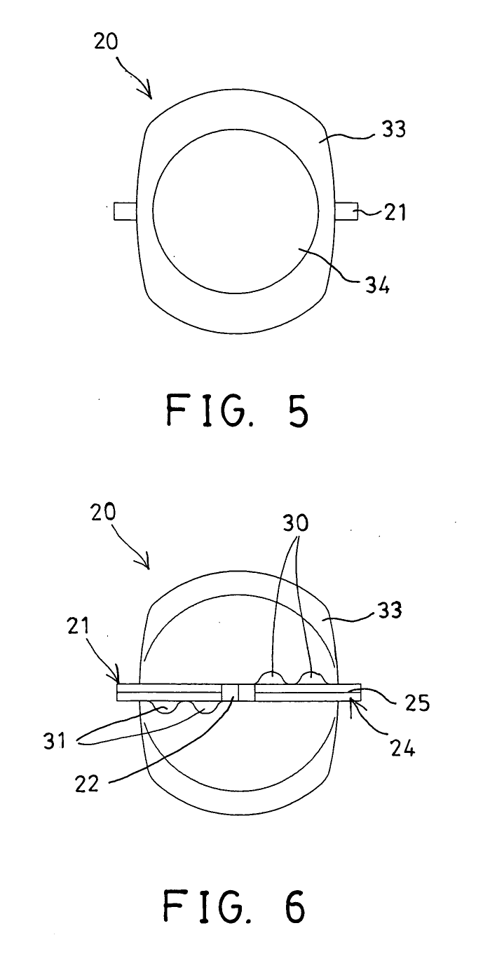

Referring to the drawings, and initially to FIGS. 1-6, a fastener device 10 in accordance with the present invention comprises a number of fastener members 20 held or supported together with one or more holding or supporting strips 80. However, the attachment or the securing of the fastener members 20 to the holding or supporting strips 80 is not related to the present invention and will not be described in further details.

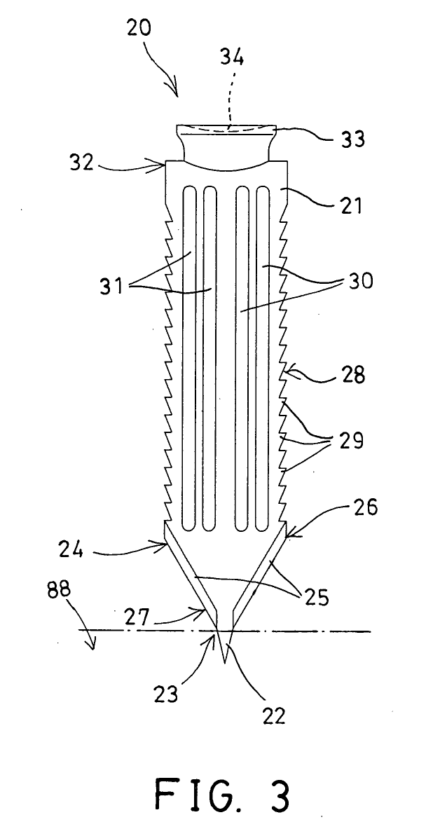

The fastener members 20 each include a planar body or plate or element 21 having a tip 22 extended from the lower portion 23 thereof for easily engaging into one or more plasterboards 88 (FIG. 3) for attaching or securing the plasterboards 88 together or for attaching or securing the plasterboards 88 to the other supporting objects or walls (not shown), and for preventing the plasterboards 88 from being broken by the fastener members 20 of the fastener device 10.

The fastener members 20 each may further include a cutting portion or member 24 formed or provided in the lower portion 23 thereof and located between the planar element 21 and the tip 22, and the cutting member 24 includes one or more cutting edges 25 formed or provided therein for further facilitating the engagement of the fastener members 20 into the plasterboards 88, and for further preventing the plasterboards 88 from being broken by the fastener members 20 of the fastener device 10.

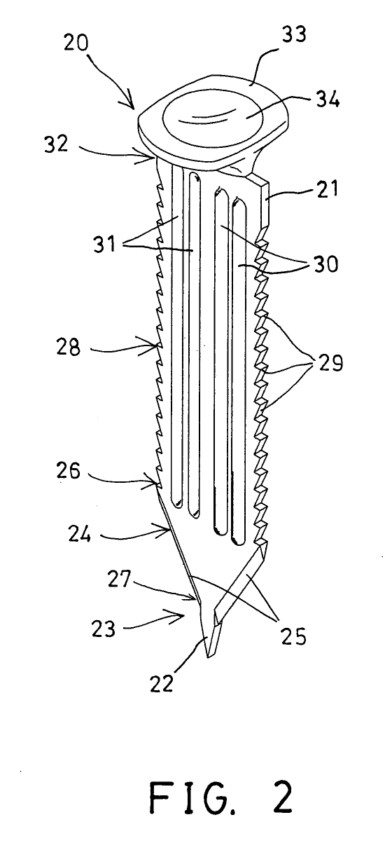

As shown in FIGS. 2 and 3, it is preferable that the cutting member 24 of the fastener member 20 includes a wider upper portion 26 adjacent or abutting the fastener member 20 or located closer to the fastener member 20, and includes a narrower lower portion 27 adjacent or abutting the tip 22 or located closer to the tip 22 for allowing the cutting member 24 of the fastener member 20 to be formed as a wedge-shape and for further facilitating the engagement of the fastener members 20 into or through the plasterboards 88.

The fastener member 20 further includes an anchoring means or device 28 formed or provided on the side portion thereof and having one or more teeth 29, such as ratchet teeth 29 provided on or extended from the side portion of the fastener member 20 for engaging with the plasterboards 88 after the fastener member 20 has been engaged into or through the plasterboards 88, and thus for anchoring or securing the fastener member 20 to the plasterboards 88 and for preventing the fastener member 20 from being disengaged from the plasterboards 88.

The fastener member 20 may further include one or more reinforcing protrusions or ribs 30 extended from one side thereof (FIGS. 2, 4, 6) and/or one or more further reinforcing protrusions or ribs 31 extended from the other side or the opposite side thereof for reinforcing the fastener member 20 and for preventing the fastener member 20 from being easily bent or distorted, and also for allowing the fastener member 20 to be effectively driven or engaged into or through the plasterboards 88.

The fastener members 20 each further include an enlarged head 33 formed or provided on or extended from the upper portion 32 of the fastener member 20 and preferably arranged perpendicular to the planar element 21 of the fastener members 20 for engaging with the plasterboards 88 and for limiting the movement or the engagement of the fastener members 20 into or through the plasterboards 88 and for preventing the fastener member 20 from being completely engaged into or through the plasterboards 88.

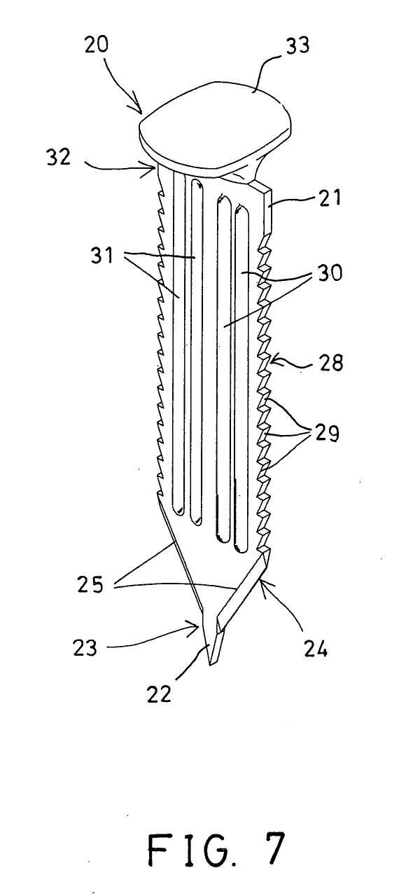

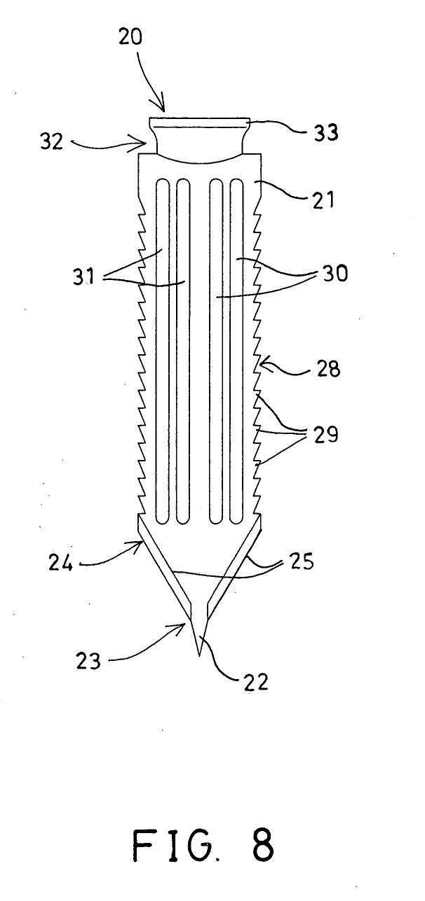

It is preferable that the enlarged head 33 of the fastener member 20 includes a cavity or curved recess 34 formed in the upper portion thereof (FIGS. 1-5) for such as centering purposes, or for facilitating the driving or the engagement of the fastener members 20 into or through the plasterboards 88, or for allowing the fastener member 20 to be easily driven or hammered by the driving tools (not shown). Alternatively, as shown in FIGS. 7 and 8, the enlarged head 33 of the fastener member 20 may include no cavities or curved recesses formed therein, but the fastener member 20 may also be driven or hammered by the driving tools (not shown).

It is to be noted that the provision of the tip 22 and/or the cutting member 24 allows the fastener member 20 to be easily driven or hammered into or through the plasterboards 88 by the driving tools and may prevent the plasterboards 88 from being broken by the fastener device 10. The anchoring means or device 28 of the fastener member 20 may anchor or secure the fastener member 20 to the plasterboards 88 and may prevent the fastener member 20 from being disengaged from the plasterboards 88. The reinforcing protrusions or ribs 30, 31 may prevent the fastener member 20 from being easily bent or distorted. The enlarged head 33 of the fastener members 20 may limit the fastener members 20 to engage into or through the plasterboards 88 and may prevent the fastener member 20 from being completely engaged into or through the plasterboards 88.

Accordingly, the fastener device in accordance with the present invention may be provided for attaching or securing plasterboards together or for attaching or securing plasterboards to the other supporting objects or walls and for preventing the fastener device from being disengaged from the plasterboards and/or the supporting objects or walls.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fastener device comprising:
a fastener member including a planar element having a tip extended from a lower portion thereof for engaging into a plasterboard, and including an anchoring means provided thereon for engaging with the plasterboard and for preventing said fastener member from being disengaged from the plasterboard.

2. The fastener device as claimed in claim 1, wherein said planar element of said fastener member includes a cutting member provided between said planar element and said tip for facilitating an engagement of said fastener member into the plasterboard.

3. The fastener device as claimed in claim 2, wherein said cutting member includes at least one cutting edge provided therein for facilitating the engagement of said fastener member into the plasterboard.

4. The fastener device as claimed in claim 2, wherein said cutting member includes a wider upper portion adjacent said fastener member and includes a narrower lower portion adjacent said tip for being formed as a wedge-shape.

5. The fastener device as claimed in claim 1, wherein said anchoring means includes at least one tooth extended from said planar element.

6. The fastener device as claimed in claim 5, wherein said at least one tooth is a ratchet tooth.

7. The fastener device as claimed in claim 1, wherein said planar element of said fastener member includes at least one first reinforcing rib extended therefrom for reinforcing said fastener member.

8. The fastener device as claimed in claim 7, wherein said at least one first reinforcing rib is extended from one side of said planar element of said fastener member.

9. The fastener device as claimed in claim 8, wherein said planar element of said fastener member includes at least one second reinforcing rib extended therefrom for further reinforcing said fastener member.

10. The fastener device as claimed in claim 9, wherein said at least one second reinforcing rib is extended from another side of said planar element of said fastener member opposite to said at least one first reinforcing rib.

11. The fastener device as claimed in claim 1, wherein said planar element of said fastener member includes an enlarged head provided on an upper portion of said fastener member for engaging with the plasterboard and for limiting an engagement of said fastener member into the plasterboard.

12. The fastener device as claimed in claim 11, wherein said enlarged head is perpendicular to said planar element of said fastener member.

13. The fastener device as claimed in claim 11, wherein said enlarged head of said planar element of said fastener member includes a curved recess formed in an upper portion thereof.
